(19) United States
(12) Patent Application Publication
(10) Pub. No.: US 2016/0360745 A1
(43) Pub. Date: Dec. 15, 2016

(54) Compositions for Purification

(71) Applicant: A Better Life Worldwide, LLC, Atlanta, GA (US)

(72) Inventors: Arthur W. Johnston, Atlanta, GA (US); Arthur F. Johnston, Atlanta, GA (US)

(21) Appl. No.: 15/224,321

(22) Filed: Jul. 29, 2016

Related U.S. Application Data
(63) Continuation-in-part of application No. 14/857,769, filed on Sep. 17, 2015, now Pat. No. 9,403,702.
(60) Provisional application No. 62/175,269, filed on Jun. 13, 2015.
(60) Provisional application No. 62/248,327, filed on Oct. 30, 2015.

(51) Int. Cl. A01N 33/00; B01J 20/20; B01J 20/10; C02F 1/28; B01D 46/00; B01D 24/02; B01D 39/06; B01D 39/04; B01D 39/02; B01D 46/30; B01J 20/04; C02F 1/50

(52) U.S. Cl. CPC A01N 33/00; B01J 20/048; B01J 20/20; B01J 20/10; C02F 1/283; C02F 1/50; C02F 1/281; B01D 24/02; B01D 39/06; B01D 39/04; B01D 39/02; B01D 46/30; B01D 46/0028; B01D 46/0036; C02F 2303/04; C02F 2101/103

(57) ABSTRACT

The invention provides compositions for purification of fluids such as water and air. In particular the invention provides a mixture of a chlorhexidine substance, a calcium phosphate compound, a carbon material and sand. The mixed compositions may be provided in the form of loose particles that optionally contain a binder that swells in the presence of a fluid to be filtered. The compositions avoid the need for pre-formation of filter cartridges and may be used in a variety of water purification devices without further adaptation. The compositions also enable rapid, economical generation of purified fluids that are essentially free of chlorhexidine. The invention can be used for either high volume applications or disposable single-use applications.

### CROSS-REFERENCE TO RELATED APPLICATIONS

This invention derives priority from a provisional US patent application having the same inventors and title, U.S. Ser. No. 62/248,327, filed Oct. 30, 2015. This invention also derives priority from a nonprovisional US patent application U.S. Ser. No. 14/857,769, filed Sep. 17, 2015, which derived priority from provisional application U.S. Ser. No. 62/175,269, filed Jun. 13, 2015, both of which had the same inventors and were entitled “Commodity Water Purifier”.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Field of the Invention

This invention relates to materials for fluid-purifying filters, and methods and devices for use of such materials, and particularly relates to removal of microbial contaminants from aqueous media and from gases.

State of the Technology

Purification of necessary fluids such as water and air is an important objective for public health. However the need to balance thrift, convenience and effectiveness presents challenges. As to thrift, populations at the lower end of the socioeconomic scale cannot afford high retail prices for treated fluids. Such price constraints impose a ceiling on operating costs for purification materials and processes unless subsidies are available, otherwise the purification is not financially sustainable. As to convenience, the maintenance, replacement and downtime for purifiers must be kept to a minimum. And as to effectiveness, purifiers must provide essentially fail-proof service for long periods under a wide variety of operating conditions.

Applications for water purification range from potable drinking water to fermentation media and separation of components in biological fluids. Applications for air purification include (re)circulated air in homes, offices, hospitals, clean rooms, air- and spacecraft. Thus products such as HEPA filters are popular to remove particulates such as dust, mold, allergens, and other material from air. And fermentation and other biotech processes are particularly important uses for compositions that remove and/or immobilize microbes.

Existing water- and air purification methods are diverse, including distillation, reverse osmosis, ion-exchange, chemical adsorption, coagulation and filtering or retention (physical occlusion of particulates). Chemical methods include the use of reagents to oxidize, flocculate or precipitate impurities. The range of particle size exclusion depends on the size of pores or interstitial spaces in membranes and granular materials, respectively. Other methods use purification materials that react chemically with contaminants. Generally complete purification requires multiple complementary techniques, thus it is common to employ several devices in series, each with a different function. Illustrative of complementary methods are mixed resins to remove negatively and positively charged species, and charge-neutral species.

The need for extensive processing and special apparati add to the cost, energy use and technical challenge of these methods. And the most economical techniques have been insufficiently effective against microbial contaminants such as bacteria and viruses. Membranes to remove components in the cellular size range are relatively costly, but the alternative is use of strong oxidizers such as bleaches, halogens, reactive oxygen species such as ozone, and the like.

The minimum standards of the Environmental Protection Agency (EPA) for accepting antimicrobial water purification devices require a 6-log reduction at minimum (99.9999%) for common coliforms, represented by the bacteria E. coli and Klebsiella terrigena, for samples in which they are present at 1×10⁷ (cells)/100 mL. For devices for which common virus removal is claimed, as represented by process-resistant poliovirus 1 (LSc) and rotavirus (Wa or SA-II), the EPA's minimum standard for devices is a 4-log reduction, 99.99% of cells, from an 1×10⁷ (cells)/L influent. Common cysts (protozoa), as represented by Giardia muris or Giardia lamblia, cause diarrhea, are difficult to treat medically, are widespread, and resist chemical disinfection. For devices that are claimed to remove cysts the EPA's minimum standard is a 3-log reduction, 99.9% of cysts removed, from 1×10⁶ (cells)/L or 1×10⁷ (cells)/L influent. The EPA has allowed the use of inanimate particles of comparable size to substitute for disease cells for purposes of testing devices to show satisfaction of these criteria.

Apatites have been used in forms such as grains, particles and fibers to bind microbial cells. Generally use of hydroxyl(l)apatite (HA) in anti-microbial water purification requires a complex process involving chemical adsorption of cells. E.g., Okamoto in U.S. Pat. No. 5,755,969 discloses use of thin, pure fibers or whiskers of HA prepared by a unique method and isolated in a particular crystal structure. Yet Okamoto warns that extracted or synthesized HA generally has poor crystallinity and adsorption, with liquid permeability that cannot be assured for microbe removal. Moreover Okamoto's reported test data shows virus reduction of at best only 99.76%. So it may not be surprising that no known commercially available filtration or purification devices incorporate apatite or HA compounds, though two decades have passed since Okamoto's discovery. A brief survey of subsequent work on comparable filters follows.

U.S. Pat. No. 5,552,046 (Johnston et al., Sep. 3, 1996) discloses a staged filter removing first >99% of particulates by a filter for 0.45-0.50 micron particles, and then removing 99.9% of bacteria and cysts by means of a filter for particles ≦0.2 microns.

U.S. Pat. No. 6,180,016 (Johnston et al., Jan. 30, 2001) discloses a pass-through fluid treatment method and device where the purification material is a porous block or sheet composed of granulated bone char (hydroxyl)apatite and absorption media such as activated carbon, in a fixed binder polymer matrix.

U.S. Pat. No. 6,187,192 (Johnston et al., Feb. 13, 2001) discloses a pass-through fluid treatment method and device where the purification material is a porous block or sheet composed of granulated bone char (hydroxyl)apatite and absorption media such as activated carbon, in a fixed binder polymer matrix. U.S. Pat. No. 6,180,016 (Johnston et al., Jan. 30, 2001) discloses a method to use such devices for water purification.

U.S. Pat. No. 6,833,075 Hughes, Dec. 21, 2004) discloses a method and device to filter and/or purify aqueous fluids with microbial and chemical impurities such as metals, water treatment chemicals and reactive chemicals, by passing the fluid through a composite material in rigid or flexible block or sheet form, in which at least one component has been surface treated.

U.S. Pat. No. 6,861,002 (Hughes, Mar. 1, 2005) discloses a method and device for the chemical conversion, filtration and/or purification of aqueous fluids such as water that have microbial and chemical impurities such as arsenic, chlorine, bacteria, viruses, and cysts. The where the fluid is passed through a (solid) treatment material composed of carbon, metal phosphates, metal oxides, reduced metals, metal silicates, metal sulfates, metal carbonates, and/or metal hydroxides, where the solids are held by a fixed binder matrix.

U.S. Pat. No. 6,878,285 (Hughes, Apr. 12, 2005) discloses a process for removing soluble and insoluble inorganic, organic, and microbiological contaminants from a fluid stream, in which fouling of ion exchange material is minimized by placing modules in line before and after the ion exchange component, where both the pre- and post-treatment modules are composites of bone charcoal, activated carbon and a binder.

U.S. Pat. Pub. No. 2004-0232068 (Hughes, Mar. 1, 2005) discloses a process of passing fluids through or over a composite purification material composed of non-expandable and expandable matter that swell through the absorption of fluid. U.S. Pat. Pub. No. 2006-0289349 (Hughes, Dec. 28, 2006) discloses the use of such expandable matter as a reservoir for time release of water treatment agents. U.S. Pat. No. 7,201,841 (Hughes, Apr. 10, 2007) discloses composite materials and devices for fluid modification, in which biocidal fluid treatment agents are generated, delivered or removed by the device by a component that is expanded by (i.e., absorbed and/or swelled by) a fluid treatment agent.

U.S. Pat. No. 7,186,344 (Hughes, Mar. 6, 2007) discloses a process of passing fluid through a pretreatment membrane of bone charcoal or bauxite to remove microbes and soluble and insoluble contaminants such as a manganese-based oxidizer or peroxide compound.

U.S. Pat. No. 7,383,946 (Hughes, Jun. 10, 2008) discloses use of solid materials permeated by a fluid containing high concentrations of a reactive oxidizer gas such as chlorine dioxide. This is said to allow rapid and safe transfer of high concentrations of the gas, for instance to disinfect and sanitize liquids among other media.

Some work on water purification has focused on chlorhexidine and its derivatives.

U.S. Pat. Pub. No. 2008-0272062 (Gooch et al, Nov. 6, 2008) discloses a pass-through fluid treatment device within which is secured a broad-spectrum antimicrobial material such as a biguanide hydrate such as chlorhexidine hydrate.

U.S. Pat. Pub. No. 2008-0306301 (Gooch et al., Dec. 11, 2008) discloses a composition for treating water, air and other fluids. It includes a biguanide dihydrate compound, such as a hydrate of chlorhexidine, with broad spectrum antimicrobial activity.

U.S. Pat. Pub. No. 2009-0191250 (Gooch et al., Jul. 30, 2009) discloses composite materials with broad spectrum antimicrobial properties for fluid treatment. The materials may include combinations of activated carbon and with particles of chlorhexidine hydrate, useful in fixed particle bed water treatment devices and methods.

U.S. Pat. Pub. No. 2010-0125105 (Gooch, May 20, 2010) discloses fibers and particulates comprising thermoplastic a polyolefin into which is blended 1-25 weight % antimicrobial bisguanide compound such as chlorhexidine. These materials are secured in a pass-through housing through which water may be flowed for antimicrobial purification.

U.S. Pat. Pub. No. 2011-0086078 (Gooch et al., Apr. 14, 2011) discloses fibrous antimicrobial materials for uses including water filtration. The materials are prepared from miscibly blended solids of bisguanides such as chlorhexidine with thermoplastic polymers, e.g. polyolefins. The materials are useful as extruded fibers or in the particulate form for preparing nonwoven materials. Methods for formation and use are also taught.

U.S. Pat. No. 7,427,409 (Gooch et al., Sep. 23, 2008) discloses broad spectrum antimicrobial materials for fluid treatment, where the materials include biguanide hydrates and bases, in particular a hydrate of chlorhexidine, C₂₂H₃₀ C₁₂N₁₀(H₂O) for water purification.

The use of chlorhexidine nevertheless poses special problems for filtration because the recovered fluid must be essentially pure. In addition to the difficulty in designing efficient and commercially viable anti-microbial systems, there are ongoing challenges in purification. Though organic contaminants may be removed by size exclusion and/or aggressive oxidation methods, dissolved inorganic toxins often are not. These include metals, many of which are toxic: aluminum, arsenic ((V) and/or the more toxic (III)), copper iron, lead and zinc are commonly found in water, as is in some cases uranium. Whether filters take up these metals depends on the charge state, pH, contact time and initial concentration. Common methods to remove them from, e.g., wastewater include chemical precipitation, membrane separation, osmosis, ion-exchange resins, solvent extraction, chemical redox reactions, coagulation and sorption; there is some overlap between these categories. Solutions are constrained not only by thrift and efficiency requirements, but also because this ubiquitous class of compounds is subject to upper concentration limits that are regularly lowered by regulatory and legislative bodies. Indeed the least amount that can be measured has been used in some rules as the threshold at which the presence of the metal is deemed excessive. Moreover there is commonly a need to remove metals from water due not to their toxicity but to their contribution to its hardness and the resulting unattractive and sometimes clogging deposits that they leave in their wake.

Thus there is an ongoing need for simple, inexpensive fluid purification compositions and filtration methods and devices that can remove particulates, cells and dissolved inorganic species. There is a further need in the art for compositions, methods and devices that meet and significantly surpass the minimum EPA specifications for microbe-eliminating water purifiers suitable for consumer and/or industrial point-of-use applications.

### BRIEF SUMMARY OF THE INVENTION

The invention provides compositions for purification of fluids such as water and air, and provides methods and devices that employ such compositions. In one embodiment the invention provides a mixture (CHM) of: a chlorhexidine (CX) substance, a calcium phosphate compound (CPC), carbon material and sand. The mixture has an unusual property that fluid passed through it carries essentially no eroded CX particles. The mixture is useful for preparing cartridges for use in water purification, wherein CHM acts to provide rigorous filtration; in a particular embodiment the rigorous filtration captures particles ≧0.2 microns in size. In another particular embodiment the invention provides CHM in a porous configuration, wherein fluid may be passed serially through two filter modules and at least one of a first and a second module comprises CHM. Hydroxy(l)apatite (HA) is useful as a CPC in the mixture, synthetic HA is particularly desirable for some marketing purposes. In particular embodiments all four of the CX substance, CPC, carbon material and sand are provided as intimately mixed solids, wherein the mixture of solids remains porous when water is passed through it. In yet another embodiment the carbon is activated carbon. In a further embodiment the mixed solids are provided in a drinking straw.

In a particular embodiment the invention provides a filtration composition for a fluid to remove any microorganisms therefrom, comprising a mixture of a chlorhexidine (CX) substance, a calcium phosphate compound (CPC), a carbon material and sand, wherein:
a) the composition is in porous form;
b) the composition remains in substantially porous form when the influent is water;
c) the amount of CX substance present is sufficient for the composition mixture to accomplish at least one of the following:
   i) a 6-log reduction in coliform bacteria Escherishia coli or Klebsiella terrigena for samples having 1×10⁷ organisms/100 mL influent;
   ii) a 4-log reduction in process resistant viruses poliovirus 1 (LSc) or rotavirus (Wa or SA-11) for samples having 1×10⁷ organisms/L influent;
   iii) a 3-log reduction in cysts Giardia muris or Giardia lamblia, for samples having a concentration in the range of 1×10⁶ to 1×10⁷ organisms/L influent; or
   iv) removal of inanimate particles of comparable size to any of those organisms to the same corresponding extent of multi-log reduction; and
d) the amount of CPC present in the composition is sufficient to ensure that immediately following filtration the fluid is essentially free of the CX substance.

In another particular embodiment the invention provides a method for filtering an influent to remove microorganisms therefrom, comprising causing the influent to flow through a mixed purification material comprising chlorhexidine (CX) substance, a calcium phosphate compound (CPC), a carbon material and sand, thereby obtaining filtered fluid, wherein:
a) the purification material is in porous form;
b) the purification material remains in substantially porous form when the influent is water;
c) the amount of CX substance present is sufficient for the mixed purification material to accomplish at least one of the following:
   i) a 6-log reduction in coliform bacteria E. coli or Klebsiella terrigena for samples having 1×10⁷ organisms/100 mL influent;
   ii) a 4-log reduction in process resistant viruses poliovirus 1 (LSc) or rotavirus (Wa or SA-11) for samples having 1×10⁷ organisms/L influent;
   iii) a 3-log reduction in cysts Giardia muris or Giardia lamblia, for samples having a concentration in the range of 1×10⁶ to 1×10⁷ organisms per L influent; or
   iv) removal of inanimate particles of comparable size to any of those organisms to the same corresponding extent of multi-log reduction; and
d) the amount of CPC present in the composition is sufficient to ensure that the filtered effluent is provided essentially free of the CX substance.

In a further embodiment the invention provides a device for filtering a fluid to remove any microorganisms therefrom, wherein the device comprises:
a) a housing having an inlet to receive influent and an outlet for the exit of effluent;
b) a purification material, wherein: comprising a mixture of chlorhexidine (CX) substance, a calcium phosphate compound (CPC), a carbon material and sand, wherein
   i) the purification material is present in a filter that is disposed to receive fluid from the inlet and to release filtered fluid to the outlet;
   ii) the purification material is a composition comprising a mixture of chlorhexidine (CX) substance, a calcium phosphate compound (CPC), a carbon material and sand;
   iii) the purification material is in porous form; and
   iv) the purification material remains in substantially porous form when the influent is water;
c) the amount of CX substance present in the purification material is sufficient for the device to accomplish at least one of the following:
   i) a 6-log reduction in coliform bacteria E. coli or Klebsiella terrigena for influent samples having 1×10⁷ organisms/100 mL influent;
   ii) a 4-log reduction in process resistant viruses poliovirus 1 (LSc) or rotavirus (Wa or SA-11) for influent samples having 1×10⁷ organisms/L influent;
   iii) a 3-log reduction in cysts Giardia muris or Giardia lamblia, for influent samples having a concentration in the range of 1×10⁶ to 1×10⁷ organisms per L influent; or
   iv) removal of inanimate particles of comparable size to any of those organisms to the same corresponding extent of multi-log reduction for influent samples; and
d) the amount of CPC present in the purification material is sufficient to ensure that immediately following filtration the fluid is essentially free of the CX substance.

### BRIEF DESCRIPTION OF THE SEVERAL VIEWS OF THE DRAWING(S)

The invention may be further understood by consideration of the drawings, each of which depicts a caricature of a non-limiting illustration of features of the invention.

FIG. 1 depicts a housing within which is contained a mixture of substances according to the invention.

FIG. 2 depicts a mixture of substances according to the invention, including a binder.

FIG. 3 depicts a system for fluid purification according to the invention, where the purification materials are provided in two distinct zones.

FIG. 4 depicts a system for fluid purification according to the invention, where the purification materials are provided in two distinct zones.

FIG. 5 depicts a system for fluid purification according to the invention, where the purification materials are contained within a single zone.

FIG. 6 depicts a system for fluid purification according to the invention, where the fluids are passed through a filter before entering a structure for use.

### DETAILED DESCRIPTION OF THE INVENTION

### Definitions

The following definitions clarify the scope and use of the invention including for compositions, devices and processes employing the invention.

The term “purification material” means a composition having the purpose of removing microorganisms or inanimate matter from an influent by means of mechanical size exclusion, physical adsorption to a surface, chemical absorption into the composition, chemical reaction with the composition, or other means.

The term “chlorhexidine substance” and “CX substance” as used herein refers to any compound in which chlorhexidine is a component. “Chlorhexidine” means the compound having the chemical designation 1,6-bis(4-chloro-phenylbiguanido)hexane. Chlorhexidine substances include but are not limited to chlorhexidine, its salts, its hydrates, and combinations thereof. The terms “chlorhexidine hydrate” and “CXH” refer to chlorhexidine that has some number of waters of association, irrespective of whether the value of that number is an integer, fraction or other number. The term “chlorhexidine salt(s)” refers to chlorhexidine that is associated with a counterion; generally but not always such salts are acid salts wherein the chlorhexidine is positively charged due to bonding with one or more acidic protons and the counterion is an anion. The invention contemplates the use of various CX salts, including but not limited to the dihydrochloride, diacetate, digluconate and citrate (CXC) salts as well as mixed salts with CX. In some embodiments the salts have integer ratios between the respective anion and cation; in others the ratio contains a non-integer.

The term “calcium phosphate compound” means a compound comprising both calcium and phosphate. Calcium phosphates useful for the present invention include calcium (Ca²⁺) salts of orthophosphates (PO₄³⁻), metaphosphates (PO₃⁻)_{n≧1} and pyrophosphates (P₂O₇⁴⁻), whether as pure salts or as mixed salts with hydrogen ions (H⁺) or hydroxide ions (OH⁻). In particularly useful calcium phosphates for the present invention are tricalcium phosphate [Ca₃(PO₄)₂] and hydroxy(l)apatite [Ca₁₀(PO₄)₆(OH)₂, sometimes denoted as Ca₅(PO₄)₃(OH)]. In particularly useful embodiments the ratio of calcium atoms to phosphorus atoms (Ca:P) in the compound is in a range from 2:1 to 1:2, inclusive, however the invention is not so limited. In some embodiments the calcium phosphate compound is derived from bone char; in other embodiments that compound is not. In certain embodiments the compound is selected from the group consisting of monophosphates, diphosphates, triphosphates, octaphosphate, orthophosphates, metaphosphates, pyrophosphates and combinations thereof. In various embodiments the compound is an apatite having the formula Ca₁₀(PO₄)₆(X)₂, where X represents one or more of hydroxyl, fluorine, chlorine, bromine, iodine and carbonate. In certain embodiments one or more phosphate moieties in the calcium phosphate compound is fully or partially acidified, e.g., the respective phosphate moiety has a formula such as PO₄H_{n≦3}, P₂O₇H_{n<3}, PO₃H_{n≦1}, etc., where n may be an integer or non-integer.

The term “calcium carbonate” has its usual and ordinary meaning in the chemical arts, and refers to the compound CaCO₃.

The term “carbon materials”—as well as the term “carbon” when used in describing the nature of a material—refers to substantially elemental forms of carbon and its allotropes, including but not limited to chars, graphite, activated carbon, diamond, and other forms of elemental carbon. The term “carbon” as used herein does not exclude the presence of surface groups such as for example hydroxyl or carboxylate moieties, and does not exclude the presence of small amounts of other elements, such as nitrogen or sulfur or metal atoms in activated carbon. By small amounts is meant, the proportions of such atoms typically found for chars made by thermolysis of natural matter such as wood, cellulose, lignin, tannins, bark, other residue from dead or living plants, animal tissue, fungal tissue, etc.

The term “activated carbon” has its usual and ordinary meaning in the filtration arts, and refers to porous carbon having a high surface area, e.g., ≧500 m²/g, available for adsorption or chemical reactions. In some embodiments activated carbon is derived from charcoal, and in others from biochar, however the invention is not limited by the source of the activated carbon or the amount of its surface area. In certain embodiments the carbon has received further chemical treatment after charring. The terms “granular activated carbon” and “granulated activated carbon” (GAC) refer to comminuted active carbon and have their usual and ordinary meaning in the art of carbon materials.

The terms “bone char” and “bone charcoal” have their usual and ordinary meaning, and refer to compositions obtained by heating animal bones at high temperature under fully or partially anaerobic conditions. The term “derived from” as used with respect to substances from bone char or bone charcoal means that the respective substances are bone char, bone charcoal or are isolated from or otherwise obtained from bone char or bone charcoal.

The term “sand” has its usual and ordinary meaning in geology. In particular it refers to a naturally occurring granular composition composed of finally divided rock and mineral particles, in which at least 85 weight percent of the particles have a respective diameter that is in the range of 1/16 mm to 2 mm. The chemical composition may include one or more that is found in natural sand, including but not limited to silicon dioxide (e.g., quartz), calcium carbonate (e.g., aragonite from coral and/or shell fragments), chert, igneous rock, gneiss, gypsum, arkose, feldspar, granite, magnetite, chlorite, glauconite, basalt, obsidian, olivine, garnet, gemstones, and other resistant minerals naturally occurring in sand. The sand used in the invention may be very fine (0.05 mm≦diameter<0.1 mm), fine (0.1 mm≦diameter<0.25 mm), medium (0.25 mm≦diameter<0.5 mm), coarse (0.5 mm≦diameter<1 mm), very coarse (1 mm≦diameter<2 mm) or any combination thereof. As used herein: the term “gravel” denotes rock and mineral particles having a size range≧2 mm; the term “silt” denotes rock and mineral particles (0.002 mm≦diameter<0.05 mm); and the term “clay” denotes rock and mineral particles having a size range<0.002 mm.

The term “inorganic” has its usual and ordinary meaning in chemistry. As used herein the term inorganic includes but is not limited to calcium phosphate compounds, calcium carbonate, elemental carbon (e.g., activated carbon), silica, other minerals, other rock compositions, trivalent and pentavalent arsenic, hydrogen sulfide, iron, copper, zinc, lead, aluminum, chromium, and uranium.

The term “amorphous” has its usual and ordinary meaning in chemistry and materials science, and in particular denotes the substantial absence of crystallinity in a referenced phase or domain of a material.

The term “binder” as used herein means a substance that acts as a glue or cement to hold solids together, and in particular to hold solid particles together. The term binder is used herein irrespective of its chemical composition: it may be organic, inorganic, metallic or any permutation or combination thereof. The term binder includes but is not limited to thermoplastic, thermoset and elastomer polymers. In some embodiments the binder absorbs moisture, whether at ambient temperature or at elevated temperatures. In certain embodiments the binder is superabsorbent, in the sense that superabsorbent is commonly understood in the art of absorbent polymers.

The term “intermingled” as used with respect to a plurality of purification materials means that they have been combined in an intimate mixture. The term is not limited to homogeneous mixtures; the intimate mixtures may optionally have heterogeneous character.

The terms “mixture” and “admixture” are used interchangeably herein, and refer to physical combinations to the extent that the components retain their original chemical identities. Non-limiting illustrative mixtures include blends, solutions, suspensions and colloids.

The term “composite form” refers to a mixture and in particular a mixture of solids.

The term “porosity,” when used in reference to pore sizes, refers to the average diameter of the pores. Purification materials comprising a calcium phosphate compound and having pore sizes in the range of 200-800 microns in diameter are particularly useful according to the invention, but the invention is not so limited.

The term “permeability” means the ability of a material to allow for the passage of a fluid.

The term “in porous form,” when used in reference to compositions according to the invention, means that the material has sufficient porosity to be permeable, and in particular means that the material has pores of a suitable size and population density to enable the material's use as a rigorous filtration medium. A common scientific unit for permeability is the darcy; a material with permeability of 1 darcy allows fluid flow of 1 cm³/s when the fluid has 1 centipoise viscosity (i.e., approximately that of water at 20° C.) under a pressure gradient of 1 atmosphere/cm acting upon a 1 cm² area. I darcy is equivalent to 0.831 m/day (i.e., 0.00000139279 cm/s), which are alternative units for representing permeability or hydraulic conductivity. Compositions having a permeability of at least 100 millidarcys allow the passage of a fluid. In particular, with respect to embodiments of mixed particulate compositions according to the invention for the filtration of water, such embodiments have a permeability of at least 100 millidarcys, at least 1,000 millidarcys, at least 10,000 millidarcys, at least 100,000 millidarcys, or at least 1,000,000 millidarcys.

The terms “porous block” and “porous sheet” as used with respect to purification materials refer to compositions in which channels of some size exist within solid blocks or sheets. Such blocks or sheets may be rigid, or alternatively may be flexible, or any combination or gradient thereof.

The term “rigorous filtration” is used in a broad sense herein with regard to the size of excluded molecules, cells and inanimate particles. It includes microfiltration (excluding by size, with a lower cut-off range of 0.1 to 10 microns, or above 10⁶ Da); dialysis methods and ultrafiltration (molecular weight cut-off in the range of 10³ Da to 10⁶ Da); nanofiltration (excluding molecules with a lower size range of 1 to 10 nm); osmosis; reverse osmosis (excluding even smaller particles but not smaller particles); and the like. In various embodiments the threshold for exclusion by size is selected from one of the following ranges: 10 microns, 1 micron, 0.1 micron, 10⁶ Da, 10⁵ Da, 10⁴ Da, 10³ Da, 10² Da, 10¹ Da, 10 nm and 1 nm. In particularly useful embodiments the rigorous filtration is at the level of ultrafiltration, or excludes particles ≧0.2 microns in diameter, but the invention is not so limited. The term “rigorous filtration medium” means a composition of matter from which a filter is constituted by which rigorous filtration is performed.

The term “fluid” means a liquid, a gas, or a combination thereof. The fluid optionally has solutes dissolved therein or has a suspension of small solids. In some embodiments the fluid comprises one or more liquids from the following group: water, an aqueous solution, a mixture primarily comprising water and ethanol, blood, a bodily fluid other than blood, (microbial) fermentation broth, and mixtures thereof. In additional embodiments the fluid comprises one or more gases from the following group: air, oxygen gas, nitrogen gas, carbon dioxide, argon gas, nitrous oxide, an anesthetic gas other than nitrous oxide, and mixtures thereof. Where the fluid is an aqueous medium, in certain embodiments it is one or a combination of: potable water, a beverage, a recycle stream in a chemical process, a recycle stream in a cell culturing process, an aqueous solution that has been used in a surgical procedure, and mixtures thereof.

The term “fluid flow” means the motion of fluid, which may be passive as under the force of gravity or capillary action, or may be forced by a pump or vacuum or other mode of flow. The term “fluid flow into and out of,” as used with respect to materials, refers to permeation of the fluid through such materials. The term “in line with” as used with respect to such flow through a component means that the flow passes serially through stages, and that the referenced component receives it at one stage and that the flow subsequently exits from the component.

The term “influent” refers to a fluid that is directed through a filtering medium. The term “influent flow” with respect to a purification material means the passage of influent into and through that material.

The term “effluent” refers to a fluid that has been passed through a filtering medium. The term “effluent flow” with respect to a purification material means the exit of filtered fluid from that material.

The terms “filter” and “filtering” have their ordinary and common meaning in water filtration, and include but are not limited to the removal of microorganisms and other impurities from water intended for use by humans. The term “filtration medium” means a composition of matter from which a filter is constituted.

The term “filtered fluid” means a fluid that has been passed through a purification material according to the invention.

The term “microorganism” has its usual and ordinary meaning in the biological and medical sciences, and includes but is not limited to bacteria, viruses, protozoa, prions, molds, single- and multi-celled algae, and single- and multi-celled yeasts and other fungi.

The term “dissolved” refers to a component for which the respective molecules and/or ions are physically dispersed essentially completely in a surrounding medium. Examples of inorganic impurities dissolved in influent include but are not limited to: trivalent arsenic, pentavalent arsenic, hydrogen sulfide, iron, copper, zinc, lead, aluminum, chromium, uranium or a combination thereof.

The term “present in a form that can adsorb a dissolved metal substance from the influent”, as used with respect to a compound, means that when such a compound is exposed to influent the compound is capable of adsorbing on its surface or absorbing into its bulk a metal in neutral, ionic or compound form that is present in the influent, thereby removing the respective metal from the influent to that extent.

The terms “impurity” and “contamination” are used interchangeably and mean an undesirable organism or other undesirable substance, whether in dissolved or undissolved form in an influent.

The term “sufficient to accomplish”, when used in reference to an amount of CX reducing the number of microorganisms or inanimate particles per quantity of influent to any particular extent, means that upon exposure of such quantities of influent to that amount of CX, the respective microorganisms or particles are removed to at least that extent.

The term “sufficient to ensure”, when used in reference to an amount of CPC as it pertains to an effluent—i.e., fluid following filtration—in a form that is essential free of a CX substance, means that: in whatever form the CPC and CX substance are respectively present in the purification material, the amount of CPC included is sufficient to adsorb or otherwise trap any erosion from the CX substance essentially completely during filtration of the corresponding fluid through the purification material, such that essentially no CX substance exits in the effluent.

The terms “6-log reduction”, “4-log reduction” and “3-log reduction”, when used in reference to numbers of organisms or particles per volume unit of influent, mean that after purification the fluid has, respectively 0.0001%, 0.01% and 0.1% of the number of such organisms or particles as were present in the influent prior to purification. The term multi-log reduction means a reduction by more than one order of magnitude, i.e., reduction in quantity by more than one power of ten. The term “reduced” as used with reference to an impurity concentration in a filtered fluid, means by comparison to that impurity's concentration in the influent prior to purification. The term “organism”, as used with respect to log reductions, means an undesirable biological organism in the influent. The units L and mL (or ml) are liter and milliliter, respectively.

The scientific names for microorganisms and their lifecycle states have their usual and ordinary meaning in the fields of medicine, microbiology, water purification; and health and sanitation. These include but are not limited to: coliform bacteria; Escherishia coli; Klebsiella lerrigena; process resistant viruses; poliovirus; rotavirus; cysts; Giardia muris; and Giardia lamblia.

The term “inanimate particle” means a particle that is comprised of non-living matter. Examples include but are not limited to dead cells; portions of dead cells; inorganic debris; and organic solids that are not composed of biological tissue. The term “comparable size”, as used when comparing inanimate particles to microorganisms, refers to the size of the inanimate particles relative to the size of the respective microorganisms.

The term “essentially free of”, as used with respect to CX or any other substance, means that the respective substance is present in at most only trace quantities. In various embodiments the amount is below 0.0001%, is undetectable, is below a threshold established by a governmental agency, or has essentially no observable effect in vitro or in vivo.

The terms “particles” and “fibers” have their usual and ordinary meaning in materials science. Fibers are to be understood as a type of particle.

The term “diameter” as used herein is to be interpreted within its context. The term “diameter” as used with respect to particles used to prepare a filtration medium has its usual and ordinary meaning for such particles, including but not only for, respectively, particles of: chlorhexidine substances; calcium phosphate compounds; carbon materials; and sand. The term “diameter” as used with respect to pore sizes has its usual and ordinary meaning in the respective context, relative to particle packing and/or to filtration materials. The term “diameter” as used with respect to lower thresholds for the size of cells and other particles captured by a filtration medium has its usual and ordinary meaning in size exclusion chromatography.

The term “regeneration” as used with respect to purification materials refers to treatment by which their purification capacity is recaptured in whole or in part. Non-limiting illustrative examples of regeneration means include sterilization protocols comprising at least one of elevated temperature, elevated pressure, radiation, a chemical oxidant, a chemical reductant, electrochemical treatment, or a combination thereof.

The term “sterilization conditions” refers to sanitation protocol conditions by which microorganisms in influent are killed. The term “stable under sterilization conditions” as used with respect to a binder for filtration media means that the binder remains substantially intact and functional as a binder when exposed to such conditions.

The term “housing” has its usual and ordinary meaning for devices, and means a surrounding structure for components. The terms “inlet” and “outlet” refer to portals for the ingress and egress of fluid through the housing, respectively. The term “contacting chamber”, when referenced as being disposed between an inlet and an outlet, means that the flow passes through such chamber while within the housing.

The term “drinking straw” means a tube by means of which water or a beverage may be sucked from a reservoir such as cup or other container.

The term “residence” refers to a structure within which one or more persons live. The term “office” refers to a structure within which one or more persons work. The term “production facility” refers to a structure within which one or more persons or machines generate products. The terms “hospital”, “cruise ship” and “water treatment plant” have their usual and ordinary respective meanings in common use.

### Chlorhexidine Substances

To be effective as a general water purifier a device or process must do each of three things successfully: (1) kill and/or remove essentially all microbial cells; (2) remove toxic metals; and (3) remove organic species. However it is common in the field to find that approaches that are effective for one objective in that combination undermine another of its objectives. An example is in use of biocides.

Chlorhexidine (CX) is a broad-spectrum biocide that acts against both gram-positive and gram-negative bacteria, as well as against fungi by a comparable mechanism. As a positively charged molecule CX binds to negatively charged cell wall sites, where it destabilizes them and interferes with osmosis across the cell envelope. Uptake of CX into the cells is rapid, typically within 20 seconds. At low CX concentrations cell walls are compromised, which can also have a bacteriostatic effect because it inhibits microbial adherence to surfaces and thus prevents formation of biofilms. At higher concentrations the cytoplasmic semipermeable inner membrane is also damaged, resulting in leakage and cell death. At even higher CX concentrations the cytoplasm congeals or solidifies. The formal name of CX is N,N″″1,6-Hexanediylbis[N′-(4-chlorophenyl)(imidodicarbonimidic diamide)]; its formula is C₂₂H₃₀Cl₂N₁₀ and its structure is shown below.

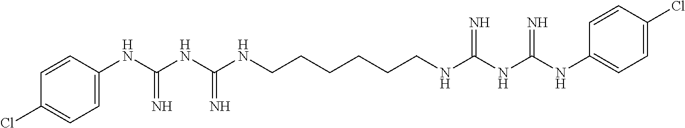 [SMILES: N=C(NCCCCCCNC(=N)NC(=N)Nc1ccc(Cl)cc1)NC(=N)Nc1ccc(Cl)cc1]

The biocidal activity of CX is both broader and faster than for antibiotics, and in vitro it can kill virtually all gram-positive and gram-negative bacteria within 30 seconds. Because CX destroys microbes from most pathogenic categories, the risk for developing opportunistic infections is low. CX has shown effectiveness against bacterial spores, protozoa, and enveloped viruses such as HSV, HIV, CMV, RSV and influenza. Because CX binds to proteins, e.g., on skin, mucosa, mouth tissue and teeth, its activity persists there for long periods (e.g., ≧48 hours), yet unlike agents such as povidone-iodine its efficacy is not undermined by body fluids such as blood. CX substances have substantial activity whether they are unmodified CX, or CX with waters of hydration, or are salts of CX.

Although the biological properties of CX substances are valuable their engineering properties are challenging. CX is practically insoluble and its melting point is high, being 134° C., both attributes of which are useful. However CX is crystalline, also it becomes impermeable when formed into a filter. The impermeability renders the filter properties moot. And even if the filter properties remained intact, the presence of CX in effluent would raise the standard for registration with the EPA and for management of the effluent.

Moreover despite its insolubility, the inventors have discovered that microparticles of at least some CX substances are eroded away by the flow of fluids during their filtration. Any water purifier that allows such emissions must be registered with the EPA as a pesticide, as opposed to a purifier, moreover the maker and/or marketer of the filter would be responsible for the ultimate fate and effects of the CXH after it leaves the filter.

In an effort to mitigate the downsides of CX, U.S. Pat. No. 7,427,409 discloses use of a hydrate, i.e., CX having 1.3 water molecules per chlorhexidine molecules, and the composition is an amorphous material from which a permeable filter can be manufactured. Like CX, CXH is essentially insoluble in water despite the waters of hydration; but CXH has a lower melting point, e.g., in the range of 92.4° C. The present invention contemplates use of CXH for any value of n for waters of hydration. However the inventors discovered that a small amount of CXH is eroded from the amorphous solid when fluid passes over or through it and thus exits with the effluent. Moreover CXH decomposes when heated, and the water of hydration evaporates at 96° C. The inventors also discovered that chlorhexidine citrate (CXC) is a preferable alternative for several applications, due to its low solubility, lower cost than CXH, and higher melting temperature than CXH. Conveniently filtration membranes are sufficient to capture essentially all of the CXC removed by the passage of water through filters comprising CXC. An illustrative range for such filters is to capture all particles >0.2 microns in size.

The present inventors have determined that the following ranges are useful for the weight percent of chlorhexidine substance present relative to the mixture (CHM): about 5-50%; about 10-45%; about 15-40°; about 20-35%; and about 25-30%; wherein each range is inclusive of its respective end values.

### Calcium Phosphate Compounds

It will be noted that where prior designs above concerned apatite or HA, the reagent or biocide was coated on a surface, embedded in a time-release material, or included as a component of a composite with the filter material. One of ordinary skill in the art would expect that a substance such as CX that is either dissolved or carried over as undissolved microparticles in pass-through fluid from a biocidal pretreatment filter would simply be likewise carried through an inorganic filter matrix and exit with the effluent. Surprisingly the inventors have discovered erosions from chlorhexidine substances sorb efficiently onto calcium phosphate compounds, thereby trapping them before they exit, moreover this phenomena is not limited to formats in which the porosity of the sorbing mixture is that of filtration.

This discovery permits use of those biocides in combination with sorbing mixtures to create products that are safe in use yet economical to manufacture and lawful to sell without registration as a pesticide with the EPA. The sorbents are now addressed in more detail.

The present inventors' initial discovery was that bone char behaves as a sorbing mixture for CX and its salts and hydrates. Bone charcoal is porous and granular, and is made by charring animal bones at 700° C. under semi-anaerobic conditions. Its main constituents are: calcium phosphates (57-80 mass %), particularly tricalcium phosphate [Ca₃(PO₄)₂] and/or hydroxylapatite [denoted as Ca₁₀(PO₄)₆(OH)₂ or less commonly as Ca₅(PO₄)₃(OH)]; calcium carbonate (CaCO₃, 6-10 mass %) and activated carbon (7-10 mass %). The actual composition depends upon the bone source and the preparation process. Generally the source is cow bones, though the skull and spines are never used due to the risk of Creutzfeldt-Jakob disease (so-called “mad cow” disease). Most of the organic composition evaporates during charring and is collected separately as an oil. The rest becomes activated carbon. Where desired, bone char that has been used for filtration or sorption can be regenerated by washing out impurities with hot water and then heating the bone char at 500° C. under semi-anaerobic conditions. Bone char adsorbs several types of ions from water, including fluoride anion, as well as metals from group 12 (copper, zinc, cadmium), and others such as arsenic and lead. Due to the relatively low surface area bone char is typically much less effective at removing organics impurities from fluids. Whereas the bones of cows and fish were particularly useful for purposes of the inventors' initial discovery; those from chicken and pigs appeared to be somewhat less effective.

As an example of bone char use, the product BRIMAC 216 sold by Tate & Lyle Process Technology may be ground to a desired particle size, e.g., 80-325 mesh. Typically by weight materials has 9-11% carbon, ≦3% acid-insoluble ash, ≦5% moisture, 70-76% hydroxylapatite (and/or tricalcium phosphate), 7-9% calcium carbonate, 0.1-0.2% calcium sulfate, and <0.3% iron (assumed to be in the form of Fe₂O₃ for purposes of calculation). That material is granular, has a total surface area of ≧100 m²/g, carbon surface area ≧50 m²/g, pore size distribution of 7.5-60,000 nm, and pore volume 0.225 cm³/g. Elements bound by this material have been reported to include CI, F, Al, Cd, Pb, Hg (both organic and inorganic), Cu, Zn, Fe, Ni, Sr, As, Cr, Mn and certain radionuclides. Organic substances bound by it include complex molecules, pesticides, color-forming compounds, flavorings for fluids, aromas for fluids, trihalomethane precursors, dyestuffs and tributyltin oxide. Bone charcoal may be supplemented by adding activated carbon, binder material, ion exchange resins, synthetic or natural zeolites, diatomaceous earth, other phosphates, and oxides of metals and/or main group elements, as desired.

Bone char on the market is safe and inexpensive for ordinary use in filters, e.g., for potable liquids. Yet the use of bone products for filtration remains problematic to the extent that they carry a stigma among the public either because of limited understanding about encephalopathic diseases or because of vegan values. Moreover like many other products derived from nature, bone char varies in composition proportions from batch to batch. The present inventors have overcome these difficulties by preparing mixtures with specific proportions of chlorhexidine substances, analytically pure calcium phosphate(s), carbon materials and sand.

Calcium phosphates useful for the present invention include, e.g., calcium (Ca²⁺) salts of orthophosphates (PO₄³⁻), metaphosphates (PO₃⁻)_{n≧1}, pyrophosphates (P₂O₇⁴⁻), triphosphates and octaphosphates, whether as pure salts or as mixed salts with hydrogen ions (H⁺) or hydroxide ions (OH⁻). Particularly useful calcium phosphates are tricalcium phosphate [Ca₃(PO₄)₂] and hydroxyl(l)apatite, but the invention is not so limited.

As to hydroxyl(l)apatite, apatite is the generic name for a usually crystalline mineral category having the formula Ca₁₀(PO₄)₆(X)₂, where X is OH (in hydroxy(l)apatite), F (in fluorapatite), or Cl (in chlorapatite). Other members include X=Br (in bromapatite); also I (in iodoapatite) is theoretically possible. Where the mineral is a mixed combination of the more common of those anions, its formula is indicated as, e.g., Ca₁₀(PO₄)₆(OH,F,Cl)₂. Hydroxy(l)apatite is present in tooth enamel and bone; in bone X may be CO₃, and PO₄H_{n≦3} substitutions may also be present. Apatite is found at concentrations of 18-40% as collophane (i.e., (sub)microscopic crystals) in phosporite sedimentary rock. Apatites may also be synthesized, such as by condensation of 10 Ca(OH)₂ with 6 H₃PO₄ to make hydroxy(l)apatite, or by condensing 3 Ca₃(PO₄)₂ and CaF₂ to make fluorapatite.

The present inventors have found that hydroxyl(l)apatite is particularly effective in adsorbing enveloped viruses and removing them from solution; the inventors believe that charges on the viral capsids are responsible for that adsorption, but the invention is not so limited. Hydroxy(l)apatite is somewhat less effective at removing or otherwise inactivating unenveloped viruses such as Rotmairus, however chlorhexidine substances are active against Rotavirus Moreover the inventors have found that other forms of apatite are useful for adsorbing both enveloped and unenveloped viruses from solution.

The following ranges are useful for the weight percent of calcium phosphate compounds present relative to the mixture (CHM): about 10-90%; about 20-95%; about 30-90%; about 40-85%; about 50-80%/o; about 60-75%; and about 70%, wherein each range is inclusive of its respective end values.

### Carbon Materials

Organic compounds are common impurities in water, air and other fluids. Some of the ways to remove them are distillation, oxidation (e.g., by ozone or bleaching compounds), digestion by microbes or enzymes (for specific classes of organics), digestion by acids (e.g., aqua regia), osmosis membranes, etc. For small amounts of organic impurities, adsorption onto carbon surfaces is particularly desirable because it is highly effective yet inexpensive. Higher surface areas increase the adsorption capacity, thus highly porous activated carbon, also called activated charcoal, activated coal or carbo activatus, is particularly useful for the invention. A surface area of ≧50 m²/g is preferred; activated carbons are available with surface areas >500 m²/g (as measured by adsorption of gas). Moreover the carbon may be obtained in chemically surface-treated form for enhanced effectiveness. Usually it is derived from biomass or charcoal and is used in particulate (i.e., granular) form. Other carbon materials and carbon allotropes may be used also or instead, including but not limited to graphite, fullerenes (i.e., carbon nanospheres, carbon nanotubes, carbon nanobuds, carbon and nanofibers), graphene (delaminated nano-sheets of graphite), glassy carbon, londaleite, carbon nanofoam, linear acetyenic carbon (carbine), amorphous carbon and its hydrogenated derivates, as well as soot, coal, and diamond.

Depending on the source the carbon may have small proportions of atoms from other elements, particularly nitrogen, sulfur and oxygen when the carbon is derived from thermal transformation of biomass. Carbons treated with hot air or chemicals may have extra surface moieties such as, for example, hydroxyl or carboxylate moieties. Typical sources of biomass include agricultural waste, forest waste, and turf waste, and may include wood, cellulose, lignin, tannins, bark, other residue from dead or living plants, animal tissue, fungal tissue, etc.

Granular activated carbon (GAC) is a particularly useful form of carbon for the invention, but it is not so limited. When GAC is used, the following ranges are useful for the weight percent relative to the mixture (CHM): about 1-50%, about 2-40%, about 3-30%, about 4-20%, about 5-10%; and about 6-8%, wherein each range is inclusive of its respective end values.

### Sand

It is necessary to maintain the porosity of the filtration mixture and facilitate a high rate of permeation of fluid through it. The inventors have found that inclusion of relatively inert small particles of rock and mineral supports fulfillment this requirement. In particular the invention employs sand for this purpose. Sand, in its unmixed state, has a typical range of porosity of 25-50%. I.e., by volume one quarter to one half of a sand sample consists of void space, into and through which air or water can move. The percentage of void space differs but is significant when sand is mixed with other powders according to the invention.

Sand is a naturally occurring granular composition composed of finally divided rock and mineral particles, in which at least 85 weight percent of the particles have a respective diameter that is in the range of 1/16 mm to 2 mm. Its chemical composition depends on the natural source, but non-limiting illustrative examples include silicon dioxide (e.g., quartz), calcium carbonate (e.g., aragonite from coral and/or shell fragments), chert, igneous rock, gneiss, gypsum, arkose, feldspar, granite, magnetite, chlorite, glauconite, basalt, obsidian, olivine, garnet, gemstones, and other resistant minerals naturally occurring in sand. The sand used in the invention may be very fine (0.05 mm≦diameter<0.1 mm), fine (0.1 mm≦diameter<0.25 mm), medium (0.25 mm≦diameter<0.5 mm), coarse (0.5 mm≦diameter<1 mm), very coarse (1 mm≦diameter<2 mm) or any combination thereof. By contrast gravel consists of rock and mineral particles with size≧2 mm; silt consists of rock and mineral particles with size 0.002 mm≦diameter<0.05 mm; and clay consists of rock and mineral particles with size<0.002 mm.

The following ranges are useful for the weight percent of sand relative to the mixture (CHM): about 1-500/%; about 5-45%; about 10-40%; about 15-35%; about 20-30%; and about 25%, wherein each range is inclusive of its respective end values.

### Binders

In certain embodiments a binder is included in the filter mixture (CHM). In certain preferred embodiments it is an expandable substance such as a superabsorbent material or another material that swells when wetted. Upon the occurrence of wetting by fluid, the expandable substance may swell to bring the mixture into intimate contact with a membrane and the housing, and also prevents channeling, and further prevents CX particulates from exiting the device. A suitable modality is taught in South African patent document 2002/8316.

The swelling of binder can serve a valuable purpose. Depending on the nature of the particles and the binder, inclusion of binder can greatly improve filtration properties. For instance, a 50:50 filter mixture of bone char and granular activated carbon but no binder allows as much as 12% of E. Coli and 8% of poliovirus in an influent to pass through the filter mixture, apparently due to channeling caused by influent and effluent flow and by the exit of particles from the device, whereas exclusion is nearly complete when the filter's composite mixture has the form of a molded or extruded block held together by about 15 weight % of a thermoplastic binder. See U.S. Pat. No. 6,180,016, in which some the present inventors were applicants. There the binder doubles as a lubricant to facilitate shearing flow of particles during molding and/or extrusion, thus a significant amount of binder is required.

Applicants find for the present invention that less binder can be used—even just 3% of binder can be sufficient—when the binder is highly swellable in a liquid fluid. The swollen binder is also soft, allowing flexibility where desired. The extent of swelling can be optimized by using a cross-linkable monomer, oligomer or polymer, because substantially cross-linked networks (such as hydrogels) have a maximum capacity. Binders that have a finite saturation value for absorption also have a maximum capacity and thus can be used in a similar way to tailor the degree of swelling. An additional benefit for ceiling values for absorption is that the binder can be prevented from expanding to fill the pores; although the filter blend might remain permeable, the viscosity of the fluid would rise and its rate of permeation across a filter could fall considerably.

For an end user the most evident benefit of including a small amount of swellable binder in the mixture is that a powder can simply be poured into an empty filtration cartridge of any size or shape, and upon wetting for a short time the mixture will be ready for filtration service. This allows facile recycling of filter devices and avoids the need for specialized pre-molded or pre-extruded cartridge sheets and blocks.

Superabsorbent polymers (also called SAPs or slush powder) absorb many times their weight in water due to hydrogen bonding: in some cases up to 500 times their weight of deionized and distilled water and up to 50 times their weight of 0.9% saline solution. As the degree of cross-linking rises, the capacity and stickiness falls but gel strength and shape retention are improved. Cellulosic materials absorb only up to 11 times their weight in water, and lose most of it under moderate pressure. Starch grafted to acrylonitrile can absorb more than 400 times its weight; various grafts of acrylic acid, acrylamide and poly(vinyl alcohol) (PVA) are also used. Sodium polyacrylate is a particularly common SAP used today, as are acrylamide copolymers, ethylene maleic anhydride copolymers, and cross-linked carboxymethylcellulose. Persons of ordinary skill in the art are familiar with methods to make such polymers in various phases, including in gels (with photo-cross-linking), solutions and suspensions.

The art also contains a well-known range of binders that have other useful properties, to the extent that they are desired. Where robustness against extreme conditions is required, such as where filters will be sterilized, binders that are suitably unreactive are employed; polyolefins, perfluoropolymers and polyethersulfones in particular may be suitable. Examples of sterilizing conditions include treatments with heat, steam, radiation (ultraviolet, infrared, microwave, and/or ionizing radiation), oxidants, reductants, formaldehyde, ethylene oxide or propylene oxide gases, beta-propiolactone, methyl bromide, reactive oxygen species, surfactants, metals, and electrochemistry. Where molding or extruding is desired, thermoplastic binders are particularly appropriate, polyolefins and nylons are non-limiting examples. Where it is desirable for the binder to have additional functionality for purification, e.g., for ion binding, the binder may be chosen from derivatized resins such as polystyrene sulfate and other polymers bearing sulfonic acid groups or their salts; poly(meth)acrylates and other polymers bearing carboxylic acid groups or their salts; polymers bearing phosphoric or phosponic acid groups and their salts; polymers bearing amine groups and their salts; polymers bearing sulfonium groups; etc. Where an electrically conductive matrix is desired for electrochemical generation of oxidative or reductive species (the matrix having, e.g., resistance less than a value in the range of 1-300 ohms), the binder may be chosen from materials such as metals (particularly but not limited to soft metals such as aluminum or copper), doped polythiophene, polypyrrole, polyaniline, polyacetylene, poly(para-phenylene vinylene), and the like, and their derivatives. Where biodegradable binders are desired, non-limiting examples include cellulose, starches, lignins, polyethylene oxides and polyethylene glycols, polylactic acids, polyvinylalcohols and their acetate esters, co-polylactideglycolides, and derivatives of any of those.

Where desired, molding and/or extrusion may be employed. Where it is desired to adapt a thermoplastic binder by heating it, for instance causing polymer particles to melt and fuse other particles in a sintering type of application, polymers may be chosen with thermal melting transitions (Tₘ) in the range of about 50-500° C., more particularly 75-350° C., even more particularly 80-200° C. E.g., that is suitable for polyolefins (Tₘ 85-180° C.), nylons and other polyamides (200-300° C.) and fluorinated polymers (300-400° C.). Similarly polymers may be selected based on glass transition temperatures (T_{g}) to attain leathery or rubbery properties at the desired use temperature, where T_{g} may be lowered by the presence and choice of plasticizers. Nonlimiting illustrative thermoplastics include: polyethylene glycols and their derivatives; polyvinyl alcohols and their esters; polylactic acids; nylons and other polyamides; polyethylenes, including LDPE, LLDPE, HDPE, and polyethylene copolymers with other polyolefins; polypropylenes; polyvinylchlorides (both plasticized and unplasticized); fluorocarbon resins such as polytetrafluoroethylene and poly(vinylidene fluoride); polystyrenes and their copolymers; cellulosic resins, such as cellulose acetate butyrates; acrylic resins, such as polyacrylates and poly(methylmethacrylate)s; thermoplastic blends or grafts such as acrylonitrile-butadiene-styrenes or acrylonitrile-styrenes; polycarbonates; polyacetals; polyesters such as polyethylene terephthalate; poly(ether ether ketone)s; and other thermoplastic polymers known to those of ordinary skill in the art.

Non-limiting illustrative thermoset polymers for use as, or inclusion in, the binder used in the invention include: polyurethanes; cross-linked silicones, cross-linked fluorosilicones; phenolic resins; and others commonly known in the art. Non-limiting illustrative elastomers for use as or inclusion in, the binder include natural and/or synthetic rubbers such as: styrene-butadiene rubbers; neoprene; nitrile rubber; butyl rubber; silicone rubbers; polyurethanes; alkylated chlorinated or chlorosulfonated polyethylene; perfluoroelastomers, ethylene-propylene-diene terpolymers, VITON (fluoroelastomer), and ZALAK (Dupont-Dow elastomer).

In certain embodiments of the invention the amount of binder used is in one of the following ranges for the percent relative to the combined weight of particles and binder; 1-25%, 2-22%; 3-19%, 4-16%, 5-13%, 6-10%, or about 8%. In some embodiments the amount is in the range of 3-7 weight percent. In various embodiments the amount is in the range of 7-12 weight percent. In other embodiments the amount is in the range of 12-17 weight percent. In particular embodiments the amount is in the range of 17-22 weight percent.

### Other Materials

Additional ingredients may be included in the purification mixture as desired, whether for purposes of supplementing adsorption or for other reasons. Non-limiting illustrative examples of additional adsorbents include ion-binding materials, such as: synthetic ion exchange resins; synthetic or natural zeolites, e.g. aluminosilicates such as clinoptilolite; diatomaceous earth; and one or more other phosphate-containing materials; such as minerals of the phosphate class and up to 200/% micronized manganese dioxide particles.

### Parameters and Utility

Composition and Proportions.

Naturally the amount of CX substance and the relative amounts of calcium phosphate compound(s), carbon material and sand depend upon the throughput volume needed and the specifications for time to replacement or regeneration of the purification media. A typical specification for a water purification cartridge is that relative to the throughput volume of water the cartridge contains enough material to provide >6-12 months of service from the cartridge when in use for water purification. And just as bone char can be regenerated, the materials in the present invention can be regenerated when desired, though their cost is low enough that they may also be treated as disposable.

Porosity and Permeability.

As is well-known to persons of ordinary skill in the design of filtration compositions for fluids, the pore size and physical dimensions of the purification particles may be manipulated for different applications, and variations in these variables will alter flow rates, back-pressure, and the level of microbiological contaminant removal. Compositions having a permeability of at least 100 millidarcys allow the passage of a fluid. In particular, with respect to embodiments of mixed particulate compositions according to the invention for the filtration of water, such embodiments have a permeability of at least 100 millidarcys, at least 1,000 millidarcys, at least 10,000 millidarcys, at least 100,000 millidarcys, or at least 1,000,000 millidarcys; millidarcys are described in the definitions section of this application. Purification materials having pore sizes in the range of 200-800 microns in diameter are particularly useful according to the invention for the flow of fluids through the purification media, but the invention is not so limited. In a non-limiting illustration, hydroxy(l)apatite with a pore size distribution of 7.5-60,000 nm and pore volume of 0.225 cm³/g is useful for the invention. In particular embodiments the average pore size is kept to several microns or less, and more particularly to less than about 1 micron, so as to exclude cysts. The pore dimensions recited here refer to the size of pores when particles are held together by a binder. In certain embodiments the CX substance, calcium phosphate compound(s), carbon material and sand are each present at 20-60 mesh size (0.250 to 0.841 mm particles, corresponding to medium- to somewhat coarse-grade with respect to sand), and have powder pore sizes in the range of 200-800 microns, depending on the particle size. In particular other embodiments hydroxy(l)apatite and/or another apatite are the calcium phosphate(s), and the purification medium has pore sizes in the rigorous filtration range, e.g. with 0.2 micrometer average diameter as the upper limit for passage of particles through the medium.

Format and Formation of Monolithic Media.

The mixed purification materials of the present invention may be used as powders per se for purification, or may be prepared as desired in the form of a block or sheet. Alternatively they may be deposited as a film disposed on a woven or nonwoven web, where the web is constituted by any thermoplastic or thermosetting resin typically used to form fabrics, e.g., polypropylene or polyethylene. Using a relatively higher proportion of binder increases the strength of the composite but decreases the pore size and available surface of the purification material; using a relatively lower proportion of binder has the opposite effect. Note that the ability to bind microbes, metal ions and radionuclides scales with the extent of available surface area of the purification material. Where desired, formation may be carried out by extrusion, compression, sintering, or other molding techniques. In a particularly useful embodiment the purification mixture contains particles (e.g., pellets) of a binder that has a high capacity to absorb water; the dry mixture is poured into a filter device, and upon introduction of water to the mixture in the device the binder swells, and the mixture becomes a solid block in the shape of the internal contours of the device. Such introduction of water may be performed by spraying, use of highly humid air, dipping, pouring, or other means.

Activity of Material Surfaces.

It is well known that different crystalline lattice structures are possible for calcium phosphate materials, e.g., for apatite, and that the interactive properties of the resulting faces varies between structure types and by axis. The faces of amorphous materials have still other differences in their interactive properties, and in fact the inventors have found that amorphous hydroxy(l)apatite is particularly advantageous for purposes of the invention. The choice of morphology for any of a CX substance polymorph, a calcium phosphate compound, a carbon material and sand (based on its origin) may thus affect the interactions with microbes, organic chemicals, and ions. In a particular embodiment, at least a portion of the calcium phosphate compound present is in the form of hydroxy(1)apatite.

### Devices

Various features may further enhance devices that contain combinations of substances according to the invention. Certain useful embodiments employ the filter mixture (CHM) in a zone that is sandwiched between a pair of membranes in a housing. Suitable membranes include but are not limited to Porex® permeable disks. In further embodiments the devices are loaded with loose particulate purification materials that contain a binder that is an expandable substance, alternatively the materials may be provided in the form of a block or a sheet. A suitable modality is taught in U.S. Pat. No. 6,180,016, there a block is prepared from a composition comprising 97% hydroxyl apatite and 3% super-absorbent material, and the block essentially serves as a containment membrane.

The device adaptability of the invention compositions is unusually broad for the relevant art. The purifying substances can be provided in mixed loose particulate form, for use in any filter device contours without reliance upon a molded filter cartridge from an original equipment manufacturer. Thus existing filters from most sources can be retrofitted readily and inexpensively. This is particularly important where pure water must be available at a low price, as in food and drug manufacturing and also for third world consumers. The invention also enables comprehensive purification by a single filter module. In particularly useful embodiments the purification mixture is placed in a module within a drinking straw. Likewise mixture may be used to create an essentially instant purification cartridge in a water supply for a residence, office, production facility, hotel, hospital, cruise ship or water treatment plant.

### Figures

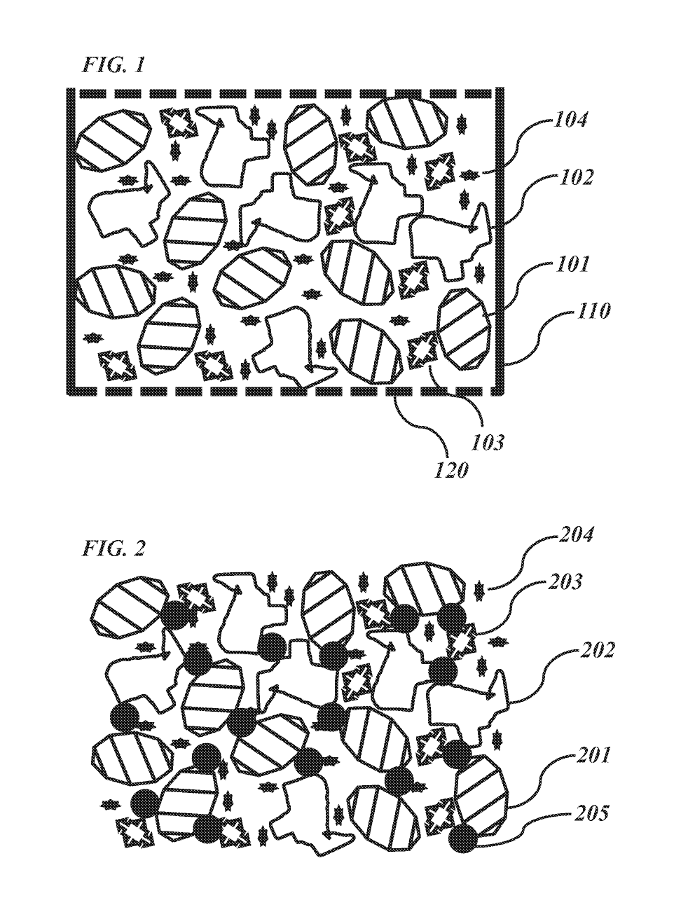

The invention may be further understood by consideration of the figures, which show features of the invention in caricature. FIG. 1 depicts a caricature of a non-limiting illustrative embodiment of a housing comprising a mixture and system according to the invention, in which a housing 110 has porous wall(s) 120, and contains a mixture according to the invention including chlorhexidine substance CX 101, a calcium phosphate compound CPC 102, and 103 and activated carbon 104.

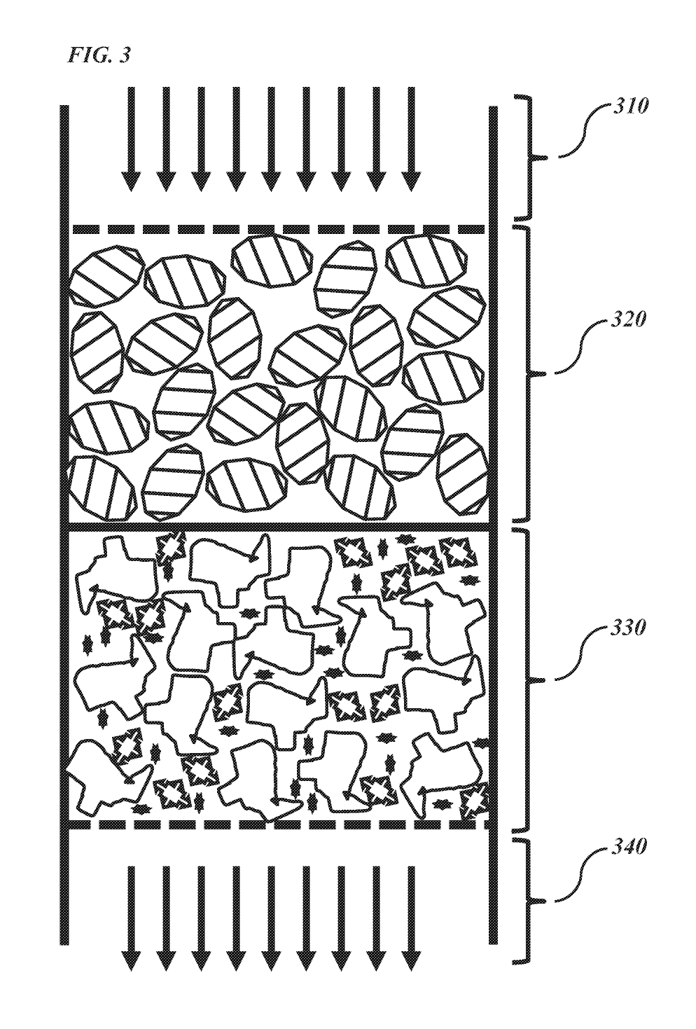

FIG. 2 depicts a caricature of a non-limiting illustrative embodiment of a mixture according to the invention in which binder is incorporated, which is useful in the preparation of porous monolithic blocks and porous flexible sheets for use as filters. Specifically FIG. 2 depicts CX 201, a calcium phosphate compound CPC 202, sand 203, activated carbon 204, and binder 205.

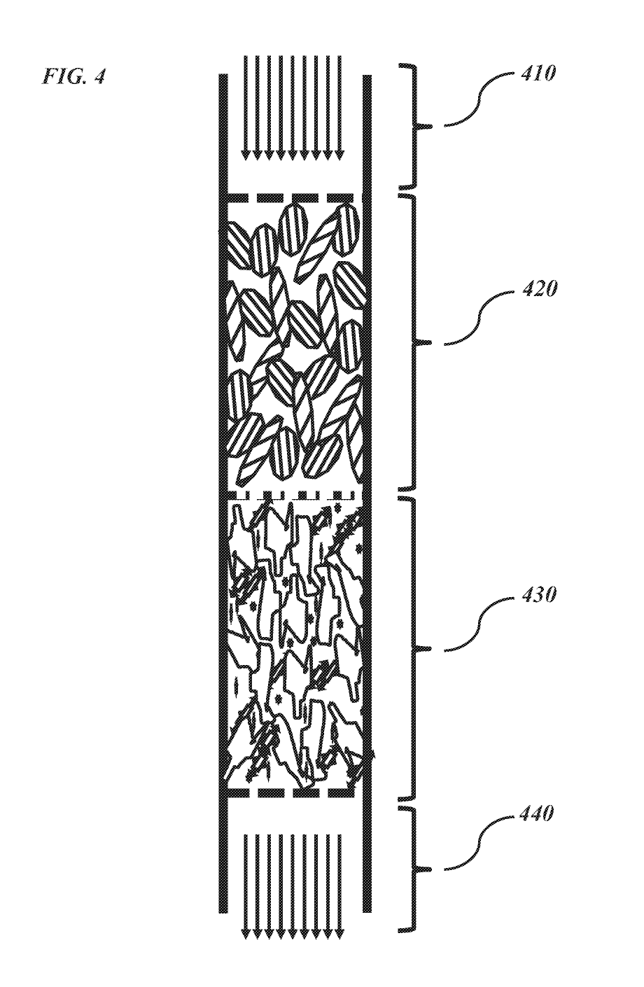

FIG. 3 depicts a caricature of a non-limiting illustrative embodiment of a purification system according to the invention, particularly including in succession: a fluid influx zone 310; a CX-containing zone 320; a zone 330 containing a calcium phosphate compound CPC, sand and activated carbon; and a fluid efflux zone 340 conveying purified fluid. The zones are separated by porous walls or porous media.

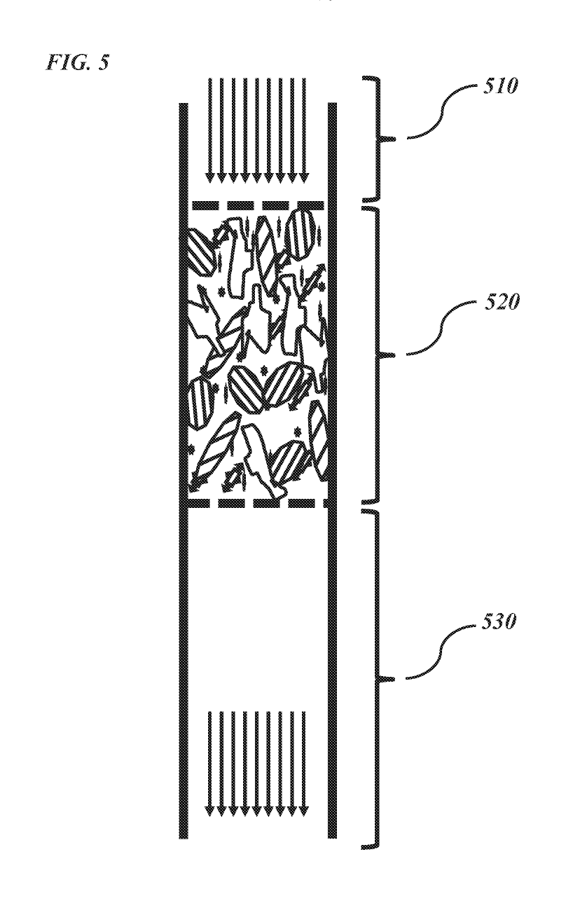

FIG. 4 depicts a caricature of a non-limiting illustrative embodiment of a purification system according to the invention, as used in a straw, pipe, tube or other channel structure. In particular it features in succession: a fluid influx zone 410; a CXC-containing zone 420; a zone 430 containing a calcium phosphate compound CPC, sand and activated carbon; and a fluid efflux zone 440 conveying purified fluid. The zones are separated by porous walls or porous media.

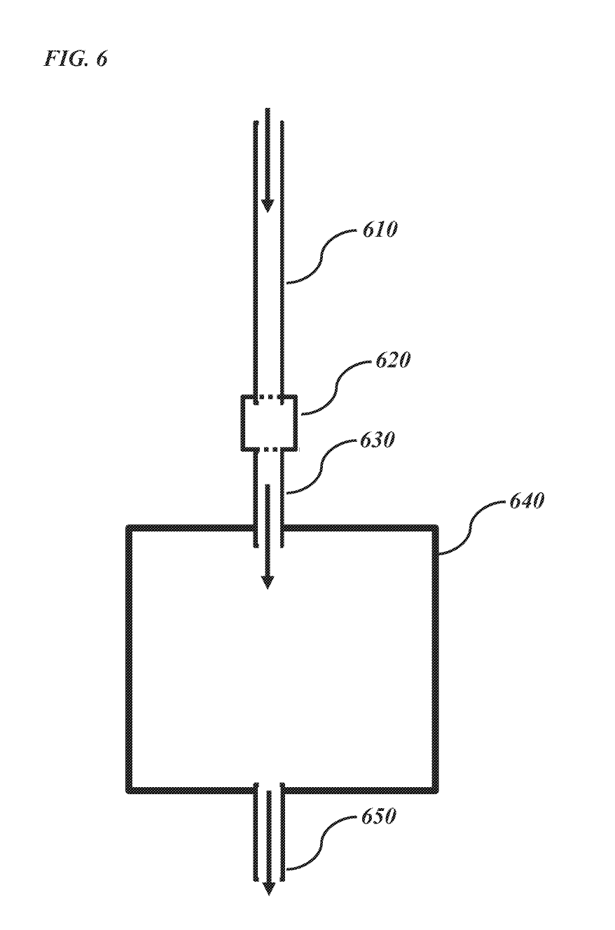

FIG. 5 depicts a caricature of a non-limiting illustrative embodiment of a purification system according to the invention, as used in a straw, pipe, tube or other channel structure. In particular it features in succession: a fluid influx zone 510; a purification containing zone 520 containing CX, a calcium phosphate compound CPC, sand and activated carbon; and a fluid efflux zone 530 conveying purified fluid. The zones are separated by porous walls or porous media.

FIG. 6 depicts a caricature of a non-limiting illustrative embodiment of a purification system according to the invention, e.g., as may be used in infrastructure. In particular it features in succession: a fluid influx zone 610; a treatment component 620 containing CX, calcium phosphate compound CPC, sand and activated carbon, each of which is optionally supplied in the form of a replaceable cartridge within the housing of the purification device and wherein treatment component 620 has porous walls or porous media located at its inlet and outlet; an influx line 630 conveying the fluid purified by 620, a facility 640 such as a residence, office, production facility, hotel, hospital, cruise ship, water treatment plant or other facility; and an efflux channel 650 conveying waste water from the facility. The treatment component includes porous wall(s) or other porous neighboring media. In some embodiments some or all of the waste water from 650 may be recycled by retreatment at 620.

The embodiments of the invention as described herein are merely illustrative and are not exclusive. Numerous additions, variations, derivations, permutations, equivalents, combinations and modifications of the above-described invention will be apparent to persons of ordinary skill in the relevant arts and are within the scope and spirit of the invention. The invention as described herein contemplates the use of those alternative embodiments without limitation.

1. A filtration composition for a fluid to remove any microorganisms therefrom, comprising a mixture of a chlorhexidine (CX) substance, a calcium phosphate compound (CPC), a carbon material and sand, wherein:
a) the composition is in porous form;
b) the composition remains in substantially porous form when the fluid is water;
c) the amount of CX substance present is sufficient for the composition mixture to accomplish at least one of the following:
i) a 6-log reduction in coliform bacteria Escherishia coli or Klebsiella terrigena for samples having 1×10⁷ organisms/100 mL influent;
ii) a 4-log reduction in process resistant viruses poliovirus 1 (LSc) or rotavirus (Wa or SA-11) for samples having 1×10⁷ organisms/L influent;
iii) a 3-log reduction in cysts Giardia muris or Giardia lamblia, for samples having a concentration in the range of 1×10⁶ to 1×10⁷ organisms/L influent; or
iv) removal of inanimate particles of comparable size to any of those organisms to the same corresponding extent of multi-log reduction; and
d) the amount of CPC present in the composition is sufficient to ensure that immediately following filtration the fluid is essentially free of the CX substance.

2. The composition of claim 1 wherein the filtration composition is in the form of particles.

3. The composition of claim 1 wherein the purification material further comprises a binder.

4. The composition of claim 3, wherein the binder is a superabsorbent polymer.

5. The composition of claim 1, wherein the CX substance is selected from the group consisting of chlorhexidine, hydrates of chlorhexidine and salts of chlorhexidine.

6. The composition of claim 1, wherein the CPC is selected from the group consisting of monophosphates, diphosphates, triphosphates, octaphosphates, orthophosphates, metaphosphates, pyrophosphates, and combinations thereof.

7. The composition of claim 1, wherein the CPC is hydroxy(l)apatite.

8. The composition of claim 1, wherein the carbon material is granular activated carbon and has a surface area of 500 m²/g.

9. The composition of claim 1, wherein at least 85 weight percent of the sand is medium or coarse and the chemical composition of the sand is selected from the group consisting of silicon dioxide, calcium carbonate, chert, igneous rock, gneiss, gypsum, arkose, feldspar, granite, magnetite, chlorite, glauconite, basalt, obsidian, olivine, garnet, and gemstones.

10. A method for filtering an influent to remove microorganisms therefrom, comprising causing the influent to flow through a mixed purification material comprising a chlorhexidine (CX) substance, a calcium phosphate compound (CPC), a carbon material and sand, thereby obtaining filtered effluent, wherein:
a) the purification material is in porous form;
b) the purification material remains in substantially porous form when the influent is water;
c) the amount of CX substance present is sufficient for the mixed purification material to accomplish at least one of the following:
i) a 6-log reduction in coliform bacteria E. coli or Klebsiella terrigena for samples having 1×10⁷ organisms/100 mL influent;
ii) a 4-log reduction in process resistant viruses poliovirus 1 (LSc) or rotavirus (Wa or SA-11) for samples having 1×10 organisms/L influent;
iii) a 3-log reduction in cysts Giardia muris or Giardia lamblia, for samples having a concentration in the range of 1×10⁶ to 1×10⁷ organisms per L influent; or
iv) removal of inanimate particles of comparable size to any of those organisms to the same corresponding extent of multi-log reduction, and
d) the amount of CPC present in the composition is sufficient to ensure that the filtered effluent is provided essentially free of the CX substance.

11. The method of claim 10 wherein the influent is a liquid selected from the group consisting of water, an aqueous solution, a mixture primarily comprising water and ethanol, blood, a bodily fluid other than blood, fermentation broth, and mixtures thereof.

12. The method of claim 10 wherein the influent is a gas selected from the group consisting of air, oxygen gas, nitrogen gas, carbon dioxide, argon gas, nitrous oxide, an anesthetic gas other than nitrous oxide, and mixtures thereof.

13. The method of claim 10 wherein the influent is an aqueous medium selected from the group consisting of potable water, a beverage, a recycle stream in a chemical process, a recycle stream in a cell culturing process, an aqueous solutions that has been used in a surgical procedure, and mixtures thereof.

14. The method of claim 10 wherein the calcium phosphate compound is present in a form that can adsorb a dissolved metal substance from the influent.

15. The method of claim 10 wherein the calcium phosphate compound is a hydroxy(l)apatite that is present in amorphous form in a purification material having a porosity of 200-800 microns in diameter.

16. The method of claim 10 wherein the purification material further comprises a binder.

17. The method of claim 10, wherein the influent comprises in a dissolved form at least one inorganic impurity selected from the group consisting of trivalent arsenic, pentavalent arsenic, hydrogen sulfide, iron, copper, zinc, lead, aluminum, chromium, uranium or a combination thereof, and wherein the filtered fluid has a reduced concentration of the inorganic impurity.

18. A device for filtering a fluid to remove any microorganisms therefrom, wherein the device comprises:
a) a housing having an inlet to receive influent and an outlet for the exit of effluent;
b) a purification material, wherein:
i) the purification material is present in a filter that is disposed to receive fluid from the inlet and to release filtered fluid to the outlet;
ii) the purification material is a composition comprising a mixture of chlorhexidine (CX) substance, a calcium phosphate compound (CPC), a carbon material and sand;
iii) the purification material is in porous form; and
iv) the purification material remains in substantially porous form when the influent is water;
c) the amount of CX substance present in the purification material is sufficient for the device to accomplish at least one of the following:
i) a 6-log reduction in coliform bacteria E. coli or Klebsiella terrigena for influent samples having 1×10⁷ organisms/100 mL influent;
ii) a 4-log reduction in process resistant viruses poliovirus 1 (LSc) or rotavirus (Wa or SA-11) for influent samples having 1×10⁷ organisms/L influent;
iii) a 3-log reduction in cysts Giardia muris or Giardia lamblia, for influent samples having a concentration in the range of 1×10⁶ to 1×10⁷ organisms per L influent; or
iv) removal of inanimate particles of comparable size to any of those organisms to the same corresponding extent of multi-log reduction for influent samples; and
d) the amount of CPC present in the purification material is sufficient to ensure that immediately following filtration the fluid is essentially free of the CX substance.

19. The device of claim 18, wherein the device is a drinking straw within which is disposed a filter.

20. The device of claim 18, wherein the device is a treatment cartridge for use in a water supply for a residence, office, production facility, hotel, hospital, cruise ship or water treatment plant.
